(19) United States
(12) Patent Application Publication
(10) Pub. No.: US 2013/0305935 A1
(43) Pub. Date: Nov. 21, 2013

(54) Peeler

(71) Applicants: Mustapha Abdulhusein Ebrahim, Hong Kong (HK); Wen Kwok Wai, Hong Kong (HK); Trevis Russel Kurz, Poland, OH (US); Christopher Hawker, Columbus, OH (US); Jessica Moreland, Columbus, OH (US); Christopher Trunek, Auburn Township, OH (US); Joel Beebe, Columbus, OH (US)

(72) Inventors: Mustapha Abdulhusein Ebrahim, Hong Kong (HK); Wen Kwok Wai, Hong Kong (HK); Trevis Russel Kurz, Poland, OH (US); Christopher Hawker, Columbus, OH (US); Jessica Moreland, Columbus, OH (US); Christopher Trunek, Auburn Township, OH (US); Joel Beebe, Columbus, OH (US)

(21) Appl. No.: 13/473,540

(22) Filed: May 16, 2012

(51) Int. Cl. A47J 17/02; B26B 11/00

(52) U.S. Cl. 99/591; 30/123.5

(57) ABSTRACT

According to certain embodiments of the present disclosure, devices are described herein for providing multiple identical or varied vegetable peeler cutting heads within a single frame.

### CLAIM OF PRIORITY

This is the first filing made with the USPTO by the applicant regarding the present disclosure.

### BACKGROUND/FIELD

Within the field of food preparation, it is known that different forms of cutting surfaces are useful for cutting and abrading various fruits and vegetables at a relatively constant depth. These devices are collectively known as vegetable peelers and described in the disclosures of U.S. Pat. Nos. 1,667,596, 2,252,094, 2,362,896, 2,614,324, 3,009,245, and 6,619,194 the teachings of which are incorporated by reference herein in their entirety. Generally, but not exclusively vegetable peelers have a cutting head which comprises first surface having a blade with a cutting edge disposed thereon and a second surface disposed at a given spacing from the first configured to mediate the cutting depth of the first surface.

Further, within the field of food preparation, it is often advantageous to use vegetable peelers having cutting heads specifically configured for the hard or soft skinned foods, as well as julienning and pattern cutting such as wave and crinkle cuts.

That said, it is often disadvantageous for a person needing multiple types of cutting heads to have such disposed upon distinct instruments.

Consequently, devices are described herein for providing multiple identical or varied vegetable peeler cutting heads within a single frame.

### SUMMARY

According to a first embodiment of the present disclosure, a folding device comprises; a peeler body, wherein the peeler body is a substantially rigid body providing operative support for a plurality of cutting heads; a plurality of cutting heads, wherein a cutting head is substantially rigid, elongated member having a first end and a second end with a sharp surface disposed therebetween and at least one of the cutting heads is a vegetable peeler; wherein the cutting heads are pivotably coupled to the peeler body at their respective first ends.

According to further embodiments of the present disclosure, a peeler has cutting heads that are coupled to the peeler body about the distal end thereof.

According to further embodiments of the present disclosure, the sharp surface of at least one of the heads is selected from one of; a soft-skin vegetable peeler, a soft-fruit vegetable peeler, a hard fruit vegetable peeler, a julienne blade, a crinkle blade, a wave blade, a smooth edged knife, a serrated knife, a granton-edged knife, a melon baller, or an olive pitter.

According to further embodiments of the present disclosure, there are protrusions extending from the surface of the peeler body sized and shaped to limit and interfere with the movement of a given cutting head thereby defining a stop in its motion.

According to further embodiments of the present disclosure, the gap between a cutting head and the peeler body narrows near respective limits of one's travel relative to the other thereby creating a frictile holding point in the motion of cutting head relative to the remainder of the assembly.

According to further embodiments of the present disclosure, there is a detent having a thin and pointed leading edge disposed upon the periphery of a cutting head, thereby defining a spade.

According to further embodiments of the present disclosure, a cutting head has a portion of material removed at a distance from the first end thereof thereby defining an area which may be engaged by the finger of an operator to unfold the device.

According to further embodiments of the present disclosure, at least one of the cutting heads comprises a distinct cutting surface and frame, wherein the frame is a substantially rigid body that provides operative support for the cutting surface.

According to further embodiments of the present disclosure, the frame is open along a portion of the cutting surface, thereby exposing such and allowing for facile cleaning and ejection of cutting waste.

According to further embodiments of the present disclosure, the cutting surface is pivotably suspended within the frame by means of complementary recesses or protrusions.

According to further embodiments of the present disclosure, the cutting head is oriented such that its long axis is offset between 0 and 90 degrees from the axis about which it is pivotably coupled to the peeler body.

According to further embodiments of the present disclosure, the frame is comprised substantially of at least one of the following plastic, resin, silicone, or metal.

According to further embodiments of the present disclosure, the peeler body has a protrusion extending substantially proximally therefrom defining a proximal meeting point for the cutting heads when folded thereagainst.

According to further embodiments of the present disclosure, a portion of the lateral part of the frame is comprised of a modified surface finish achieved by applying an emboss, detent, or over-molding to provide either purely aesthetic treatment or such that the device may be more securely gripped by a user.

According to further embodiments of the present disclosure, the axises about which the cutting heads are coupled to the peeler body are substantially co-planar.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows an isometric view of a peeler in a first, folded configuration.

FIG. 2 shows an isometric view of a peeler in a second full-open configuration.

FIG. 3 shows an isometric view of a peeler in a third, partially open configuration.

FIGS. 4a, 4b, and 4c show isometric views of three embodiments of a cutting head.

FIG. 5 shows an isometric view of a peeler body.

### DETAILED DESCRIPTION OF THE FIGURES

Various embodiments of the presently disclosed apparatus will now be described in detail with reference to the drawings, wherein like reference numerals identify similar or identical elements. In the drawings and in the description that follows, the term “proximal,” will refer to the end of a device or system that is closest to the operator, while the term “distal” will refer to the end of the device or system that is farthest from the operator. Similarly, anatomical terms of reference such as dorsal, lateral, anterior, and sagittal shall have their accepted meanings in the arts. Where features are referred to with subletters in addition to numbers, this shall denote repeated similar although not necessarily identical elements.

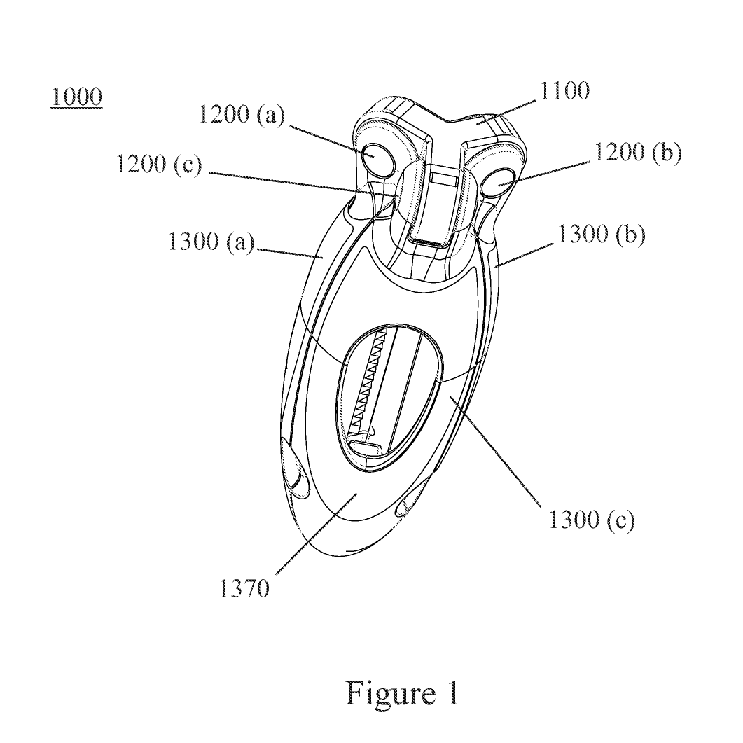

Referring now to FIG. 1, a first embodiment of a peeler 1000 is shown in a first configuration. A peeler 1000 comprises a peeler body 1100 pivotably coupled about pins 1200(a-c) to a plurality of cutting heads 1300(a-c).

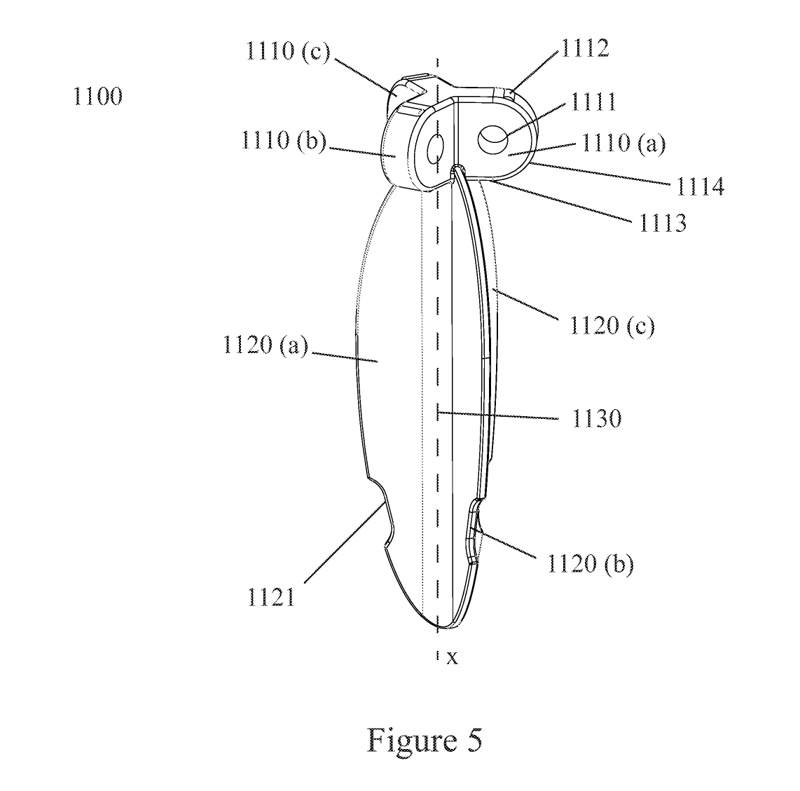

Referring now to FIG. 5, a peeler body 1100 is shown as an elongated member having a long axis X extending therethrough from which a number of features extend in a substantially medial direction. About the distal-end portion of peeler body 1100, there are three protrusions 1110(a-c) extending medially therefrom. According to the embodiment of the present disclosure shown in the figures, protrusions 1100 are radially spaced from one another at substantially equal intervals.

With continued reference to FIG. 5, protrusions 1110(a-c) are themselves comprised of an aperture 1111 sized and shaped to receive a complementary pin therewithin, an arcuate bearing surface 1114, as well as a first stop 1112 and a second stop 1113 extending in a substantially medial direction from aperture 1111.

Arcuate surface 1114 is shown as being equidistant from aperture 1111 along its entire path. That said, there are further embodiments of the present disclosure, where portions of surface 1114 are farther from aperture 1111 and sized and shaped to frictily engage corresponding portions of a cutting head thereby defining frictile holding points for the travel of a given cutting head. First stop 1112 and second stop 1113 are two examples of such holding points extending even further, as they are sized and shaped to mechanically interfere and define the limits of the travel of a given cutting head. Although stop 1112 and stop 1113 are shown as being disposed upon surface 1114, there are further embodiments of the present disclosure wherein there are mechanically equivalent stops extending from other portions of protrusions 1110(a-c).

With continued reference to FIG. 5, there are three ribs 1120(a-c) extending medially from the proximal-end portion of peeler body 1100. Ribs 1120(a-c) are thin members extending substantially medialy from a core 1130. The peripheral surface of ribs 1120(a-c) is substantially arcuate so as to substantially accommodate the shape of a given cutting head when such is folded therebetween. There are recesses 1121 disposed upon ribs 1120(a-c) such that a cutting head may be engaged by the finger or nail of an operator for facile opening.

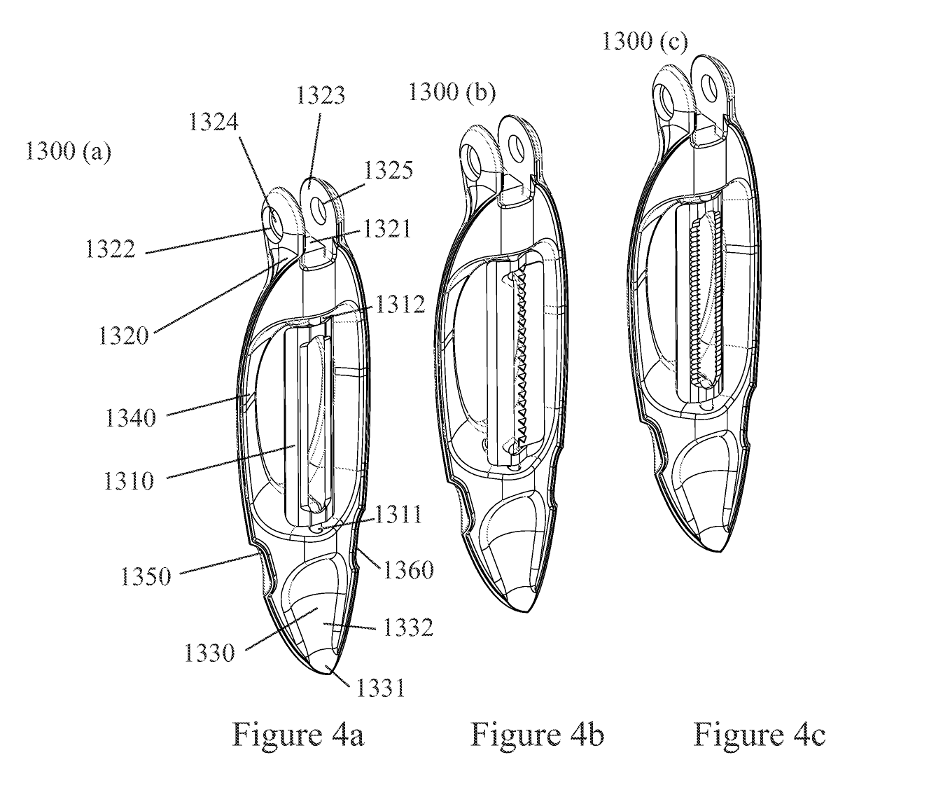

Referring now to FIGS. 4a, 4b, and 4c together, three embodiments of cutting heads 1300(a-c) are shown having a straight vegetable peeler, julienne blade, and soft-skin peeler disposed therewithin. There are further embodiments of the present disclosure wherein the cutting heads comprise a crinkle blade, a wave blade, a smooth edged blade, a serrated blade, a paring knife, a granton-edged knife, a melon baller, an olive pitter, or other suitable device known in the culinary arts.

Beginning with the distal end thereof, cutting heads 1300(a-c) further comprise a head portion 1320 sized and shaped to be pivotably engaged about aperture 1111 by a pin 1200. Head portion 1320 is comprised of two substantially planar protrusions 1322 and 1323 extending distally therefrom and having concentric apertures 1324 and 1325 extending therethrough. There is a surface 1321 disposed upon the proximal-end portion of head 1320 sized and shaped to interfere with stops 1112 and 1113.

Moving proximally, there is a blade 1310 pivotably coupled to cutting heads 1300(a-c) by substantially co-axial apertures 1311 and 1312. Blade 1310 has a anterior cutting face and a posterior face. The posterior face of blade 1310 is substantially enclosed by the body of cutting head 1300(a-c). There is an aperture 1340 disposed upon the central portion of cutting head 1300(a-c) sized and shaped to allow access to a portion of the posterior face of blade 1310 so as to allow facile cleaning and removal of extra material therefrom.

With continued reference to FIGS. 4a, 4b, and 4c together, there are complementary regions 1350 and 1360 disposed upon the periphery of cutting heads 1300(a-c) corresponding to recess 1121 disposed upon peeler body 1100, such that when assembled, a gap is created about which a user may grasp a given cutting head so as to translate it pivotally relative to the remainder of the assembly.

Referring now the proximal-end portion of cutting heads 1300(a-c), there is a spade portion 1330 disposed thereupon which has a thin, pointed tip 1331 at the periphery of the cutting head and an arcuate bowl 1332 therebehind. Spade portion 1330 is sized and shaped such that a user may use it to remove undesirable portions from a piece of foodstuff, including for instance the eye from a potato. Although the tip 1331 is shown as having a smooth edge, there are further embodiments of the present disclosure wherein all or a portion of tip 1331 has one or more serrations disposed thereupon.

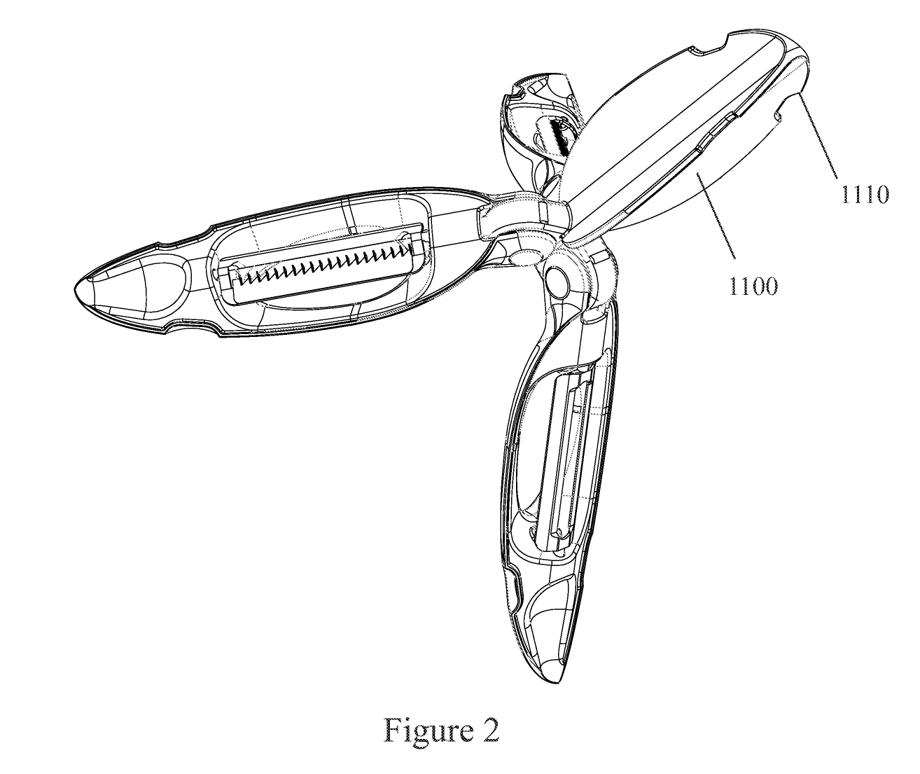

With returning reference to FIGS. 1, 2, and 3, an assembled peeler is shown, wherein cutting heads 1300(a-c) are pivotably coupled to peeler body 1310 by a plurality of pins 1200(a-c). There is an over-molded portion of softer plastic or silicone 1370 disposed about the external surface of cutting heads 1300(a-c) operatively configured to improve a user's grip on the device.

A method of using a peeler will now be described. Initially, a peeler 1000 is provided in a first, closed condition as shown in FIG. 1 with each cutting head abutting its respective first stop 1113. Next, a user grasps the peeler in their first hand such that none of cutting head 1300(a) is covered by their first hand. Next, a user grasps portions 1350 and 1360 of cutting head 1300 between their thumb and forefinger and translates cutting head 1300(a) along its rotational path until arrested by stop 1112. In the embodiments of the present disclosure where bearing surface 1114 is shaped to frictilly interfere with and retain cutting head 1300(a), the cutting head is held in place by such friction.

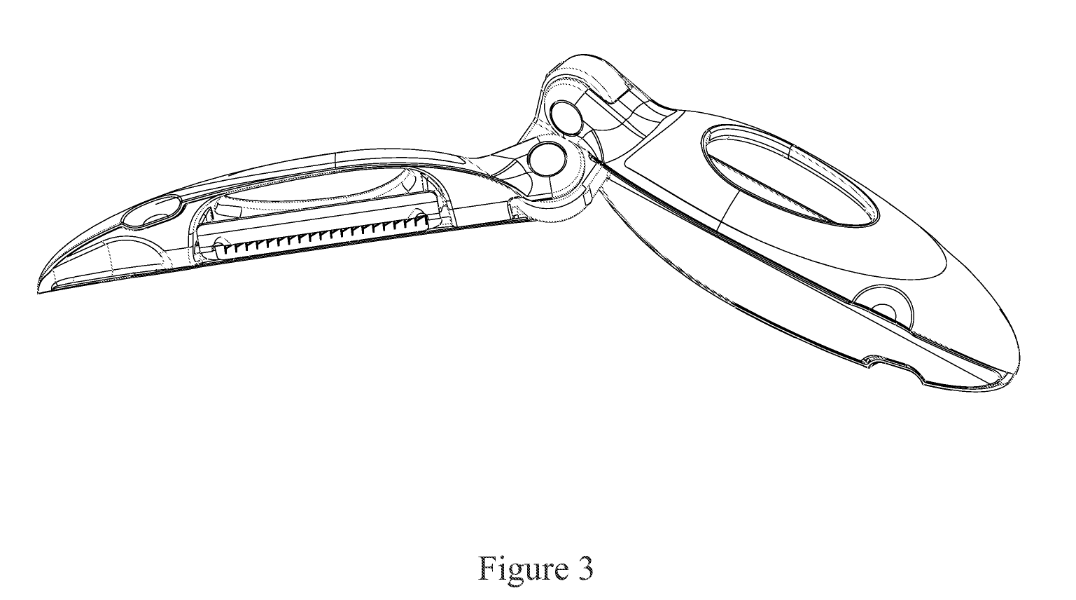

The peeler is now configured in a second configuration as shown in FIG. 3. In such a configuration, the peeler may be used as a conventional vegetable peeler, paring knife, or other kitchen tool corresponding to the blade selected. When a user is done with their cooking task, the blade may be cleaned by a brush or running water through aperture 1340. Finally, a user may return the device to its initial configuration for storage.

Although the preceding features have been shown and described as being implemented using molded plastic and silicone, there are further embodiments of the present disclosure and claims that can be implemented using formed and shaped metal including for instance bent metal frames as shown in the U.S. Pat. No. 2,362,896 patent.

What is claimed is:

1. A folding device comprising;
a device body,
wherein the device body is a substantially rigid body providing operative support for a plurality of cutting heads;
a plurality of cutting heads,
wherein a cutting head is substantially rigid, elongated member having a first end and a second end with a sharp surface disposed therebetween and at least one of the cutting heads is a vegetable peeler;
wherein the cutting heads are pivotably coupled to the device body at their respective first ends.

2. The folding device of claim 1, wherein the cutting heads are coupled to the device body about the distal end thereof.

3. The folding device of claim 1, wherein the sharp surface of at least one of the heads is selected from one of; a soft-skin vegetable peeler, a soft-fruit vegetable peeler, a hard fruit vegetable peeler, a julienne blade, a crinkle blade, a wave blade, a smooth edged knife, a serrated knife, a granton-edged knife, a melon baller, or an olive pitter.

4. The folding device of claim 1, wherein there are protrusions extending either laterally or distally from the device body sized and shaped to limit and interfere with the movement of a given cutting head thereby defining a stop.

5. The folding device of claim 1, wherein the gap in the interface between a cutting head and the device body narrows thereby creating a frictile holding point in the motion of cutting head relative to the remainder of the assembly.

6. The folding device of claim 1, wherein there is a detent have a thin and pointed leading edge disposed upon the periphery of a cutting head, thereby defining a spade.

7. The folding device of claim 1, wherein a cutting head has a portion of material removed at a distance from the first end thereof thereby defining an area which may be engaged by the finger of an operator.

8. The folding device of claim 1, wherein at least one of the cutting heads comprises a distinct cutting surface and frame, wherein the frame provides operative support for the cutting surface.

9. The folding device of claim 8, wherein the frame is open along a portion of the cutting surface, thereby exposing such and allowing for facile cleaning and ejection of cutting waste.

10. The folding device of claim 8, wherein the cutting surface is pivotably suspended within the frame.

11. The folding device of claim 1, wherein the cutting head is oriented such that its long axis is offset between 0 and 90 degrees from the axis about which it is pivotably coupled to the device body.

12. The folding device of claim 8, wherein the frame is comprised substantially of at least one of the following plastic, resin, silicone, or metal.

13. The folding device of claim 1, wherein the the body has a protrusion extending substantially proximally therefrom defining a proximal meeting point for the cutting heads when folded thereagainst.

14. The folding device of claim 8, wherein a portion of the lateral part of the frame is comprised of a modified surface finish achieved by applying an emboss, detent, or over-molding such that the device may be more securely gripped by a user.

15. The folding device of claim 1, wherein the axes about which the cutting heads are coupled to the device body are substantially co-planar.

16. The folding device of claim 13, wherein the protrusion provides operative support for the cutting heads at at least on point of their length when such are folded.

17. A folding device comprising;
a device body, wherein the device body is a substantially rigid body providing operative support for a plurality of cutting heads; a plurality of cutting heads, wherein a cutting head is substantially rigid, elongated member having a first end and a second end with a sharp surface disposed therebetween and at least one of the cutting heads is a vegetable peeler; wherein the cutting heads are pivotably coupled to the device body at their respective first ends; wherein the sharp surface of the second surface is selected from at least one of; a soft-skin vegetable peeler, a soft-fruit vegetable peeler, a hard fruit vegetable peeler, a julienne blade, a crinkle blade, a wave blade, a smooth edged knife, a serrated knife, a granton-edged knife, a melon baller, or an olive pitter.
